(19) United States
(12) Patent Application Publication
(10) Pub. No.: US 2024/0248742 A1
(43) Pub. Date: Jul. 25, 2024

(54) INITIATING EXECUTABLE CONTAINERS IN TRUSTED EXECUTION ENVIRONMENTS

(71) Applicant: Red Hat, Inc., Raleigh, NC (US)

(72) Inventors: Alice Frosi, Cottbus (DE); Sergio Lopez Pascual, Zaragoza (ES)

(21) Appl. No.: 18/157,501

(22) Filed: Jan. 20, 2023

(51) Int. Cl. G06F 9/455

(52) U.S. Cl. CPC G06F 9/45558; G06F 2009/45583; G06F 2009/45587

(57) ABSTRACT

The technology disclosed herein enables enhancing trusted execution environments with dedicated agents configured to initialize containers. An example method includes identifying, by an agent running in a trusted execution environment, an encrypted first disk image including data associated with an executable container. The agent may store an empty second disk image. The agent may further encrypt, using one or more keys generated by the agent, the second disk image and create a file system on the encrypted second disk image. The agent may further decrypt the encrypted first disk image and generate an overlay between the decrypted first disk image and the encrypted second disk image.

### TECHNICAL FIELD

The present disclosure is generally related to cluster computing environments, and more particularly, to initiating executable container in trusted execution environments.

### BACKGROUND

Cluster computing environments can provide computing resources, such as host computer systems, networks, and storage devices that can perform data processing tasks and can be scaled to handle larger tasks by adding or upgrading resources. Virtualization techniques can be used to create multiple virtual machines (VMs) on each physical host computer system, so the host computer systems can be used more efficiently and with greater flexibility. A hypervisor may run on each host computer system and manage multiple virtual machines. Such virtualization techniques thus provide abstractions of the physical components into logical objects to allow running various software modules, for example, multiple operating systems, concurrently and in isolation from other software modules, on one or more interconnected physical computer systems. Virtualization allows, for example, consolidating multiple physical servers into one physical server running multiple virtual machines to improve the hardware utilization rate.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a block diagram of an example cluster management system that manages a containerized cluster, in accordance with one or more aspects of the present disclosure;

FIG. 2 depicts a block diagram illustrating components and modules of an example computer system, in accordance with one or more aspects of the present disclosure;

FIG. 3 depicts a flow diagram of an example method for initiating an executable container in a trusted execution environment, in accordance with one or more aspects of the present disclosure;

FIG. 4 depicts a block diagram of a computer system operating in accordance with one or more aspects of the present disclosure;

FIG. 5 depicts a flow diagram of another example method for initiating an encrypted executable container in a trusted execution environment, in accordance with one or more aspects of the present disclosure;

FIG. 6 depicts a flow diagram of an example method for sharing a container disk image of an executable container running in a trusted execution environments, in accordance with one or more aspects of the present disclosure;

FIG. 7 depicts a block diagram of a computer system operating in accordance with one or more aspects of the present disclosure; and

FIG. 8 depicts a block diagram of an illustrative computer system operating in accordance with one or more aspects of the present disclosure.

### DETAILED DESCRIPTION

Described herein are systems and methods for initiating executable container in trusted execution environments. Various computing environments may utilize confidential computing technologies, such as Trusted Execution Environments (TEEs), to enhance security and confidentiality of services running within those environments. A execution environment may encrypt data when it is stored on disk and when it is in transit. The trusted execution environments may enable the computing environments to encrypt the data of the service while it is in-use by the computers. A trusted execution environment may be implemented at the hardware level using the central processing unit (CPU) of the computer. The trusted execution environment encrypts the data of a process that provides the service while the data is in memory and in use by the CPU. The encryption can occur at a firmware level and can be set up so that the cryptographic keys are inaccessible to any and all operating system processes executing on the computer. In an illustrative example, the TEE may be implemented by an Intel® Software Guard Extensions (SGX) secure enclave, which is a private region of encrypted memory, the contents of which would only be decrypted for access by the process running within the enclave. In another illustrative example, the TEE may be implemented by the AMD® Secure Encrypted Virtualization (SEV), which encrypts the memory state of each virtual machine using a respective encryption key inaccessible by other virtual machines. Various other TEE implementations for the above-referenced and/or other processor architectures may be compatible with the systems and methods of the present disclosure.

A containerized cluster may be a collection of physical or virtual host computer systems (host systems) that run applications. The containerized cluster may include entities that represent resources in the cluster, such as virtual machines, nodes, persistent volumes, and networks. The containerized cluster may run on-premises or in a cloud. A containerized application may run in association with a container, which may handle infrastructure-related tasks such as deployment of the application for operation. A container may be a unit of software that packages code and its dependencies, so the application runs quickly and reliably across computing environments. The container may include the application and the application's dependencies, which may include libraries and configuration information.

Container engines are systems that may be used for performing deployment, scaling, and management of containers across a containerized cluster. In some system, a container may consist of multiple layers (e.g., partitions) of software or libraries, along with metadata indicating a relationship between the layers. In one example, a container may be implemented by a multi-layer disk image that includes a writable layer (a layer with read and write permissions) overlayed over one or more read-only layers. The writeable layer may be used as a filesystem to store data related to the execution of the read-only layers. Container engines may use storage drivers to create and manage these filesystems.

To limit the usage of storage space, a container disk image consisting of the read-only layers can be shared between multiple containers. However, confidential computing technologies makes sharing the container disk image impractical, since the writable layer overlayed on the container disk image is encrypted with a cryptographic key known only to the corresponding container instance. Therefore, the container disk image cannot be shared without sharing the cryptographic key, thus breaking the confidentiality of the confidential computing technologies. Accordingly, it is desirable to provide the ability to share the container disk image of containers executed using confidential computing technologies.

Aspects of the present disclosure address the above-noted and other deficiencies by enhancing trusted execution environments with dedicated agents configured to initialize containers. In an illustrative example, a host(s) may run a node (e.g., a virtual machine) that operates a trusted execution environment. The trusted execution environment may run a software agent (hereafter “agent”), such as a device driver. To generate a container in the trusted execution environment, a container engine may obtain (e.g., perform a pull operation) a container disk image(s) from, for example, an image repository. In some implementations, the container disk image may a pre-encrypted disk image, such as, for example, an OCI (open container initiative) encrypted disk image. The container disk image may include one or more read-only layers related to a executing a container. The container engine may also generate an empty disk image. The empty disk image may be a writable disk defined by the storage capacity (e.g., 100 megabytes (MBs)), and used to store data related to the execution of a container. The container engine may store or upload both the encrypted container disk image and the empty disk image in the trusted execution environment. In an example, the container engine may present, to the host, the encrypted container disk image and the empty disk image as two separate block devices.

An agent running in trusted execution environment may generate one or more cryptographic keys and encrypt the empty disk image. Encrypting the empty disk image means that files and data subsequently stored on the encrypted disk image will also be encrypted prior to storage, thus requiring cryptographic data (e.g., a cryptographic key) to access. The agent may then create a filesystem on the encrypted empty disk image. The filesystem may be used to control how data, related to the execution of the container, is stored and retrieved. The agent may then decrypt the encrypted container disk image and overlay the encrypted empty disk image atop the decrypted container disk image. For example, the agent may combine two or more mount points (directories on a filesystem) into a single mount point, resulting in a single directory structure that contains the underlying files and sub-directories from both disk images. Accordingly, the host may run the container in the trusted execution environment.

In some implementations, the same encrypted container disk image may be shared by multiple containers operating in respective trusted execution environments of different nodes, while each container may receive and operate its own empty disk image. This is due to the container disk image consisting of only read-only layers, and each trusted execution environments may receive the cryptographic keys to decrypt the container disk image. Accordingly, aspects of the present disclosure enable sharing a container disk image between multiple containers while providing each container with its own encrypted workspace in respective trusted execution environments.

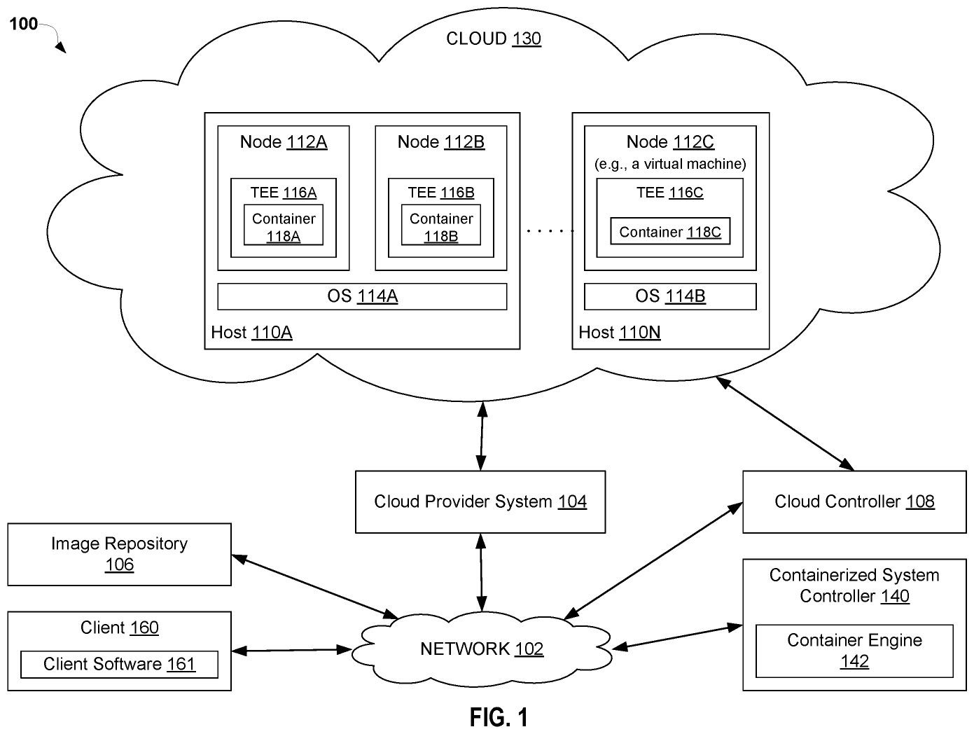

FIG. 1 is a block diagram of a network architecture 100 in which implementations of the disclosure may operate. In some implementations, the network architecture 100 may be used in a containerized computing services platform. As discussed above, a containerized computing services platform may include a Platform-as-a-Service (PaaS) system, such as OpenShift® or Kubernetes®. The PaaS system provides resources and services (e.g., micro-services) for the development and execution of applications owned or managed by multiple users. A PaaS system provides a platform and environment that allow users to build applications and services in a containerized cluster environment (the “cloud”). Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

As shown in FIG. 1, the network architecture 100 includes a cloud-computing environment 130 (hereafter “cloud 130”) that includes nodes 112A-C to execute applications and/or processes associated with the applications. A “node” providing computing functionality may provide the execution environment for an application of the PaaS system. In some implementations, the “node” may refer to a virtual machine (VM) that is hosted on a physical machine, such as host 110A through host 110N, implemented as part of the cloud 130. For example, nodes 112A-B are hosted on physical machine of host 110A in cloud 130 provided by cloud provider 104. In some implementations, an environment other than a VM may be used to execute functionality of the PaaS applications. When nodes 112A-C are implemented as VMs, they may be executed by operating systems (OSs) 114A-B on each host 110A-N.

In some implementations, hosts 110A-N are often located in a data center. Users can interact with applications executing on the cloud-based nodes 112A-C using client computer systems, such as one or more clients 160 via corresponding client software 161. Client software 161 may include an application such as a web browser. In other implementations, the applications may be hosted directly on hosts 110A-N without the use of VMs (e.g., a “bare metal” implementation), and in such an implementation, the hosts themselves are referred to as “nodes”.

Client(s) 160 may be connected to hosts 110A-N in cloud 130 and the cloud provider system 104 via a network 102, which may be a private network (e.g., a local area network (LAN), a wide area network (WAN), intranet, or other similar private networks) or a public network (e.g., the Internet). Client 160 may be a mobile device, a PDA, a laptop, a desktop computer, a tablet computing device, a server device, or any other computing device. Each host 110A-N may be a server computer system, a desktop computer or any other computing device. The cloud provider system 104 may include one or more machines such as server computers, desktop computers, etc.

In various implementations, developers, owners, and/or system administrators of the applications may maintain applications executing in cloud 130 by providing software development services, system administration services, or other related types of configuration services for associated nodes in cloud 130. This can be accomplished by accessing cloud 130 using an application programmer interface (API) within the applicable cloud service provider system 104. In some implementations, a developer, owner, or system administrator may access the cloud service provider system 104 from a client device (e.g., client 160) that includes dedicated software to interact with various cloud components. Additionally, or alternatively, the cloud service provider system 104 may be accessed using a web-based or cloud-based application that executes on a separate computing device that communicates with a client device via network 102.

In some implementation, the cloud provider system 104 is coupled to a cloud controller 108 via the network 102. The cloud controller 108 may reside on one or more machines (e.g., server computers, desktop computers, etc.) and may manage the execution of applications in the cloud 130. In some implementations, cloud controller 108 receives commands from containerized system controller 140. In view of these commands, the cloud controller 108 provides data (e.g., such as pre-generated images) associated with different applications to the cloud provider system 104. In some implementations, the data may be provided to the cloud provider 104 and stored in an image repository 106, in an image repository (not shown) located on each host 110A-N, or in an image repository (not shown) located on each node 112A-C. This data may be used for the execution of applications for a containerized computing services platform managed by the containerized system controller 140.

In some implementations, the image repository 106 may include one or more container disk images. A container disk image may consist of multiple layers (e.g., partitions) of software or libraries, along with metadata indicating a relationship between the layers. Each layer may be one or more of a writeable layer (e.g., a layer with read and write permissions), a read-only layer, etc. The container disk image may be used to initialize a respective container in one or more node 112A-112C. In some implementations, a container disk image may be encrypted (e.g., an OCI encrypted disk image). The cryptographic key to decrypt the encrypted container disk image may also stored on image repository 106, or obtained via a server or client device via, for example network 102.

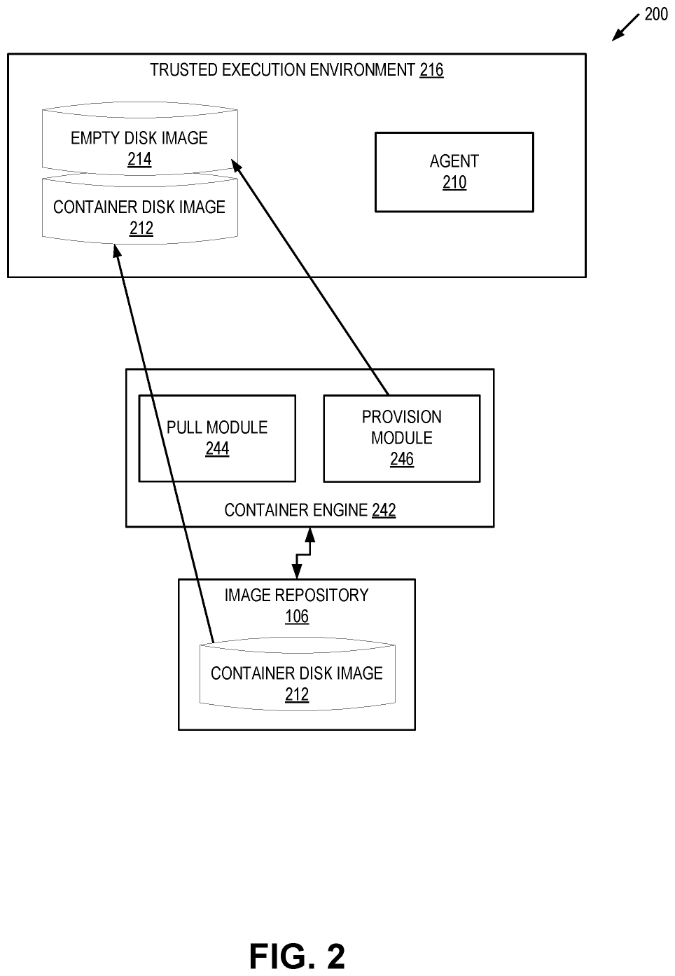

In some implementations, the data is used for execution of containers 118A-C in trusted execution environments 116A-C, respectively. Trusted execution environments 116A-C may protect data using techniques that enhance data confidentiality, data integrity, data availability, or a combination thereof. Trusted execution environments 116A-C may protect the data using hardware based encryption that isolates the data of a service (e.g., container 118A-C, VM, process, web application, etc.) while it is in use by a processor and protects the data from other processes running on the same computing device. In one example, the data of a process executing in the trusted execution environment may be encrypted using cryptographic keys that are accessible to a hardware processor of the computing device but are inaccessible to all the processes running on the computing device (e.g., hardware level encryption). The hardware processor may encrypt or decrypt the data of the process executing in the trusted execution environment when the process stores or accesses the data. This enables the trusted execution environment to isolate data of a lower privileged process (e.g., application process or virtual machine process) executing within the trusted execution environment from being accessed by a higher privileged processes (e.g., kernel or hypervisor) even though the higher privileged processes may be responsible for managing the lower privileged process. Trusted execution environments 116A-C may provide code execution, storage confidentiality, and integrity protection, and may store, execute, and isolate data of a service from other processes executing on the same computing device. In some implementations, trusted execution environment 116A-C may include an agent (not shown) configured to initialize a container (e.g., container 118A-C). The agent will be explained in detail in FIG. 2 below.

Containers 118A-C may include application images built from pre-existing application components and source code of users managing the application. An image may refer to data representing executables and files of the application used to deploy functionality for a runtime instance of the application. In one implementation, the image can be built using a Docker™ tool and is referred to as a Docker image. In other implementations, the application images can be built using other types of containerization technologies. An image build system (not pictured) can generate an application image for an application by combining a preexisting ready-to-run application image corresponding to core functional components of the application (e.g., a web framework, database, etc.) with source code specific to the application provided by the user. The resulting application image may be pushed to image repository 106 for subsequent use in launching instances of the application images for execution in the PaaS system.

In various implementations, a container 118A-C can be a secure process space on the nodes 112A-C to execute functionality of an application. A process space is the volume of memory which is allocated for potential memory addresses related to a computing device. In some implementations, a container 118A-C is established at the nodes 112A-C with access to certain resources of the underlying node, including memory and storage. In one implementation, the containers 118A-C may be established using the Linux Containers (LXC) method. In further implementations, containers 118A-C may also be established using cgroups, SELinux™, and kernel namespaces, to name a few examples.

In some implementations, the containerized system controller 140 may include a container engine 142 that performs container management operations related to trusted execution environments for the cloud-based PaaS system described above. In some implementations, container engine 142 may obtain one or more container disk images from image repository 106 and store the container disk image on trusted execution environment 116A-C. For example, container engine 142 may perform a pull operation to obtain the container disk image. In other implementations, container engine 142 may obtain the container disk image(s) from other sources, such as a server, a client device, the Internet, etc. In some implements, container engine 142 may generate an empty disk image. Container engine 142 may then store the empty disk image in trusted execution environment 116A-C.

In some implementations, storing a disk image on trusted execution environment 116A-C can include container engine 142 executing a storage driver correlated to trusted execution environment 116A-C. A storage driver may be a software interface that uses a particular protocol for storing data in a particular storage destination. Examples of storage drivers can include a virtual file system (VFS) driver or an object-storage driver (e.g., a cloud-storage driver or a blob-storage driver). In some implementations, container engine 142 may have multiple storage drivers, with each storage driver being for storing data in a respective storage destination (e.g., a respective trusted execution environment 116A-C).

While aspects of the present disclosure describe the container engine 142 as implemented in a PaaS environment, it should be noted that in other implementations, the container engine 142 can also be implemented in an Infrastructure-as-a-Service (Iaas) environment, such as Red Hat OpenStack®. Additionally, while for simplicity of illustration, FIG. 1 depicts a single cloud 130, aspects of the present disclosure may be implemented to perform container management operations related to trusted execution environments across multiple clouds 130. In such instances the container engine 142 may perform container management operations related to trusted execution environments for hybrid cloud environments, multi-cluster cloud environments, or the like. Container engine 142 is described in further detail below with respect to FIG. 2.

FIG. 2 depicts a block diagram illustrating example components and modules of computer system 200 which includes technology facilitating management of a container in a trusted execution environment, in accordance with one or more aspects of the present disclosure. The components and modules discussed herein may be performed by any portion of supervisor 110 (e.g., kernel/hypervisor) or by an application, virtual machine, container, other portion of a computing system, or a combination thereof. More or less components or modules may be included without loss of generality. For example, two or more of the modules may be combined into a single modules, or features of a module may be divided into two or more modules. In one implementation, one or more of the modules may reside on different computing devices (e.g., a client device and a server device).

Computer system 200 may include container engine 242, image repository 106 and trusted execution environment 216. Trusted execution environments 216 may be implemented on a processing device and protect data using hardware-based encryption that isolates the data of a container while it is in use by a processor and protects the data from other processes running on the same computing device. In some implementations, trusted execution environment 216 may correspond to trusted execution environment 116A-C.

Container engine 242 may perform container management operations related to trusted execution environment 216. In particular, container engine 242 may provide disk images (e.g., container disk images, empty disk images, etc.) to trusted execution environment 216. Container engine 242 may then instruction an agent (e.g., agent 210) of trusted execution environment 216 to initialize a container using the disk images. In some implementations, container engine 242 may correspond to container engine 142. Container engine 242 may include pull module 244 and provision module 246.

Pull module 244 may perform operations related to obtaining one or more container images. In some implementations, in response to receiving a request (from, for example, node 112A-C, client 160, etc.) to initialize a container in trusted execution environment 216, pull module 244 may obtain, from image repository 106, container disk image 212. In other implementations, pull module 244 may obtain the container disk image 212 from a server, a client device, the Internet, etc. In some implementations, container disk image 212 may be encrypted using, for example, asymmetric encryption methods (e.g., Rivest Shamir Adleman (RSA), Digital Signature Standard (DDS), Elliptical Curve Cryptography (ECC), etc.), using symmetric encryption methods (e.g., Data Encryption Standard (DES), Advanced Encryption Standard (AES), etc.), hashing functions (e.g., Secure Hash Algorithm, such as, SHA-128 or SHA-256), or any other encryption method.

Pull module 244 may store obtained (encrypted) container disk image 212 on trusted execution environment 216. For example, pull module 244 may send or upload container disk image 212 to trusted execution environment 216. In some implementations, pull module 244 may present, to trusted execution environment 216 (or to the host execution trusted execution environment 216), container disk image 212 as a block device (e.g., a virtual block device). A block device may be any nonvolatile mass storage device whose information can be accessed in any order.

Provision module 246 may generate empty disk image 214. In some implementations, the disk image may be defined by one or more of a storage capacity (e.g., 100 megabytes (MBs)), a format (e.g., NTFS (New Technology File System), FAT32 (File Allocation Table32), etc.), and/or by other parameters. The empty disk image 214 may be used to store data related to the execution of a container. In some implementations, empty disk image 214 is a writable disk image. Provision module 246 may store empty disk image 214 on trusted execution environment 216. For example, pull module 244 may send or upload empty disk image 214 to trusted execution environment 216. In some implementations, provision module 246 may present, to trusted execution environment 216 (or to the host execution trusted execution environment 216), empty disk image 214 as a block device. In some implementations, encrypted container disk image 212 and empty disk image 214 may appear, to the hosting node (e.g., node 112A-C), as two different block devices in trusted execution environment 216.

Agent 210 may be implemented by trusted execution environment 216. Agent 210 may be any software agent, device driver, or computer program configured to react to its environment and run without continuous direct supervision to perform one or more functions related to initializing a container in trusted execution environment 216. In some implementations, agent 210 may be configured to execute operations of a storage driver.

Agent 210 may perform operations to encrypt empty disk image 214. In some implementations, agent 210 may generate one or more cryptographic keys to encrypt empty disk image 214. The cryptographic key(s) may be accessible only by the processor device running trusted execution environment 216. Accordingly, the cryptographic key(s) may be inaccessible to all the processes running on the host computer system (e.g., host 110A).

Agent 210 may create a filesystem on the encrypted empty disk image 214. The filesystem may be a data structure used to control how data is stored and retrieved from the encrypted empty disk image 214. Accordingly, since the empty disk image 214 is encrypted with one or more cryptographic key(s) accessible only to trusted execution environment 216, applications (e.g., containers) operating within trusted execution environment 216 may be able to write, access, or modify data stored on encrypted empty disk image 214.

Agent 210 may decrypt container disk image 212 using cryptographic data (e.g., certificates and/or cryptographic keys such as authentication keys, signature keys, endorsement keys, session keys, encryption or decryption keys), hash data (e.g., hash, digital signature), identification data (e.g., processor model or security version), configuration data (e.g., program version, hardware version, firmware version, security version, settings, registry data), other data, or a combination thereof. The cryptographic data to decrypt container disk image 212 may be obtained from image repository 106, container engine 142, client 160, etc. For example, agent 216 may decrypt container disk image 212 using one or more cryptographic keys obtained from image repository 106.

Agent 210 may execute an overlay operation to create an overlay of the encrypted empty disk image 214 and the unencrypted container disk image 212. An overlay operation may be any operation used to merge data from two or more disk images (e.g., empty disk 214 and container disk image 212). In some implementations, performing the overlay operation may involve executinging a Docker™ “overlay” driver or Docker™ “overlay2” driver. In some implementations, agent 210 perform the overlay operation may involve executing a chroot operation that changes a root file system to a particular partition directory.

In an illustrative example, agent 216 may launch (e.g., execute) container disk image 212 and combine two or more mount points (directories on a filesystem) from empty disk image 214 and the unencrypted container disk image 212 into a single mount point. The resulting directory structure created by the overlay operation may contain files and sub-directories from both disk images. The container generated by the overlay operation may be executed in trusted execution environment 216, where data corresponding to the execution of the container may be stored on encrypted empty disk image 214.

In some implementations, the container may share container disk image 212 with one or more other nodes 112A-112C. For example, container 118A running in trusted execution environment 116A of node 112A may share container disk image 212 with node 112B and/or node 112C (or their respective containers 118B, 118C). In some implementations, sharing may include agent 210 granting access, to another node or container, access to container disk image 214. In some implementations, sharing may include agent 210 notifying another node or container of an identifier (e.g., address location, related metadata, etc.) related to container disk image 212. In some implementations, agent 210 may also share (e.g., send, grant access to, notifying of an identifier, etc.) cryptographic data (e.g., cryptographic keys) for decrypting container disk image 212. Since the layers of container disk image 212 are read-only layers, node 112B and/or node 112C are unable to modify container disk image 212, thus preventing possible corruption of container 118A.

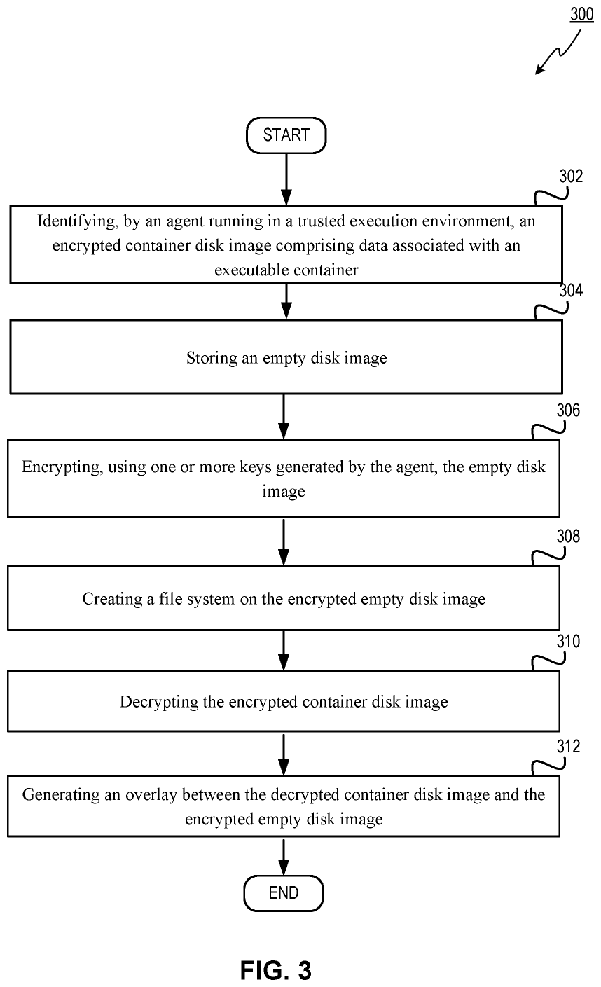

FIG. 3 depicts a flow diagram of an example method 300 for initiating an executable container in a trusted execution environments, in accordance with one or more aspects of the present disclosure. Method 300 and each of its individual functions, routines, subroutines, or operations may be performed by one or more processors of the computer device executing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processes implementing method 300 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 300 may be performed by an executable code of a host machine (e.g., host operating system or firmware), a virtual machine (e.g., guest operating system or virtual firmware), an external device (e.g., a PCI device), other executable code, or a combination thereof.

Method 300 may be performed by one or more processing devices of a computing process, a host, a node, a client device, a server, etc., and may begin at block 302. At block 302, an agent running in a trusted execution environment identifies an encrypted container disk image that includes data associated with an executable container. The encrypted container disk image may include one or more read-only layers. In some implementations, the encrypted container disk image may be presented, to the agent by a container engine, as a virtual block device.

At block 304, the agent stores an empty disk image. The empty disk image may be stored on the trusted execution environment. The agent may grant, to the executable container, write access to the empty disk image. In some implementations, the empty disk image may be presented, to the agent by a container engine, as a virtual block device.

At block 306, the agent encrypts, using one or more keys generated by the agent, the empty disk image.

At block 308, the agent creates a file system on the encrypted empty disk image. In some implementations, the agent may generate, on the encrypted empty disk, a file system for storing data associated with the container.

At block 310, the agent decrypts the encrypted container disk image.

At block 312, the agent generates an overlay between the decrypted container disk image and the encrypted empty disk image. In some implementations, the agent may generate the overlay by merging data from the decrypted container disk image and from the encrypted empty disk image. In some implementations, the agent may grant, to another agent running in another trusted execution environment, access to the encrypted container disk image. In some implementations, the agent may provide, to the another agent, cryptographic data (e.g., a cryptographic key(s)) to decrypt the encrypted container disk image. Responsive to completing the operations described herein above with references to block 312, the method may terminate.

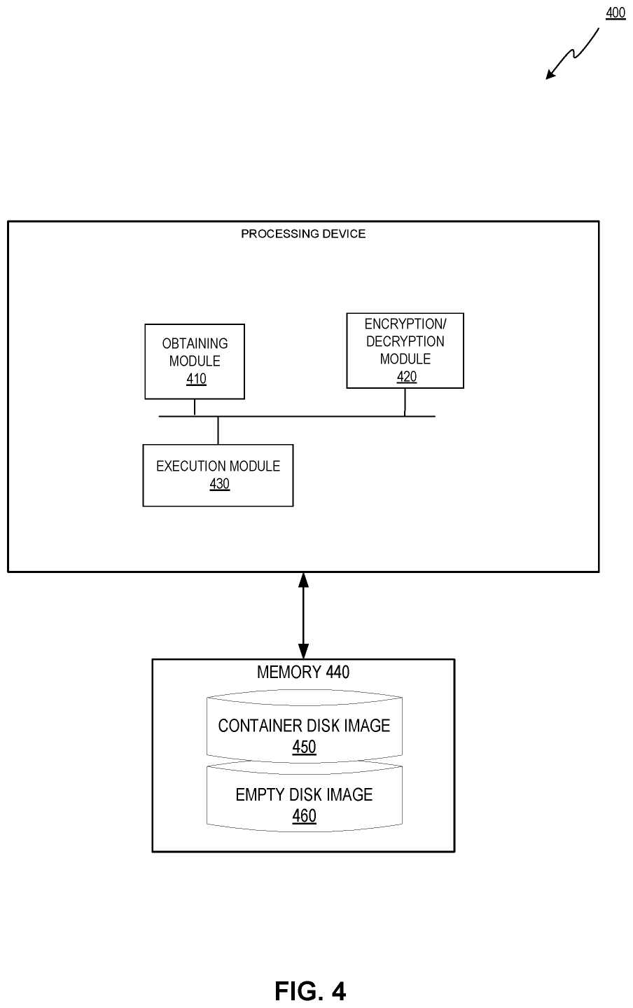

FIG. 4 depicts a block diagram of a computer system 400 operating in accordance with one or more aspects of the present disclosure. One or more of the components of FIG. 1 and/or FIG. 2 may execute on computer system 400. Computer system 400 may be the same or similar to node 112A-C of FIG. 1 and/or computer system 200 of FIG. 2, and may include one or more processors and one or more memory devices. In the example shown, computer system 400 may includes obtaining module 410, encryption/decryption module 420, execution module 530, and memory 440, which may include container disk image 450 and empty disk image 460. The processing device may run a trusted execution environment, in which modules 410-430 operate. In some embodiments, memory 440 may be a data structure maintained by the processing device.

Obtaining module 410 identifies encrypted container disk image 450 that includes data associated with an executable container. Encrypted container disk image 450 may include one or more read-only layers. In some implementations, encrypted container disk image 450 may be presented, to obtaining module 410 by a container engine, as a virtual block device.

Obtaining module 410 may store empty disk image 460 on memory 440. Empty disk image 460 may be stored on the trusted execution environment. Obtaining module 410 may grant, to the executable container, write access to empty disk image 460. In some implementations, empty disk image 460 may be presented, to obtaining module 410 by a container engine, as a virtual block device.

Encryption/decryption module 420 may encrypt, using one or more keys generated by encryption/decryption module 420, the empty disk image. Encryption/decryption module 420 may also decrypt the encrypted container disk image 450

Execution module 430 may create a file system on the encrypted empty disk image 460. In some implementations, execution module 430 may generate, on encrypted empty disk 460, the file system for storing data associated with the container.

Execution module 430 may generate an overlay between the decrypted container disk image 450 and the encrypted empty disk image 460. In some implementations, execution module 430 may generate the overlay by merging data from the decrypted container disk image 450 and from the encrypted empty disk image 460.

In some implementations, obtaining module 410 may grant, to another processing device running in another trusted execution environment, access to the encrypted container disk image 450. In some implementations, obtaining module 410 may provide, to the other processing device, cryptographic data (e.g., a cryptographic key(s)) to decrypt the encrypted container disk image 450.

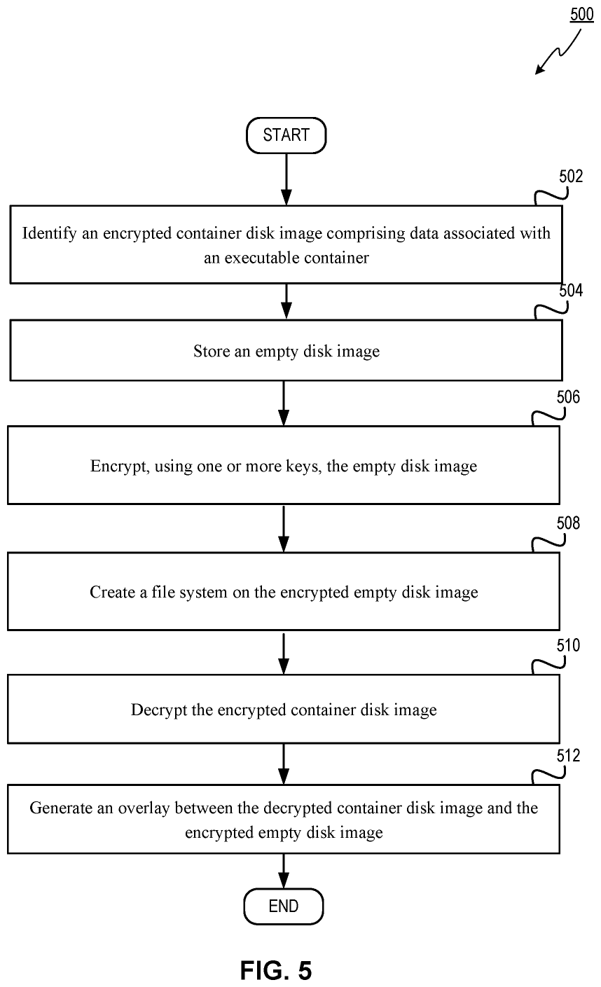

FIG. 5 depicts a flow diagram of one illustrative example of a method 500 for initiating an executable container in a trusted execution environments, in accordance with one or more aspects of the present disclosure. Method 500 may be similar to method 300 and may be performed in the same or a similar manner as described above in regards to method 300. Method 300 may be performed by processing devices of a server device or a client device and may begin at block 502.

At block 502, a processing device, running in a trusted execution environment, identifies encrypted container disk image that includes data associated with an executable container. The encrypted container disk image may include one or more read-only layers. In some implementations, the encrypted container disk image may be presented, to the agent by a container engine, as a virtual block device

At block 504, the processing device stores an empty disk image. The empty disk image may be stored on the trusted execution environment. The processing device may grant, to the executable container, write access to the empty disk image. In some implementations, the empty disk image may be presented, to the processing device by a container engine, as a virtual block device.

At block 506, the processing device encrypts, using one or more keys generated by the agent, the empty disk image.

At block 508, the processing device creates a file system on the encrypted empty disk image. In some implementations, the processing device may generate, on the encrypted empty disk, a file system for storing data associated with the container.

At block 510, the processing device decrypts the encrypted container disk image.

At block 512, the processing device generates an overlay between the decrypted container disk image and the encrypted empty disk image. In some implementations, the processing device may generate the overlay by merging data from the decrypted container disk image and from the encrypted empty disk image. In some implementations, the processing device may grant, to another processing device running another trusted execution environment, access to the encrypted container disk image. In some implementations, the processing device may provide, to the other processing device, cryptographic data (e.g., a cryptographic key(s)) to decrypt the encrypted container disk image. Responsive to completing the operations described herein above with references to block 512, the method may terminate.

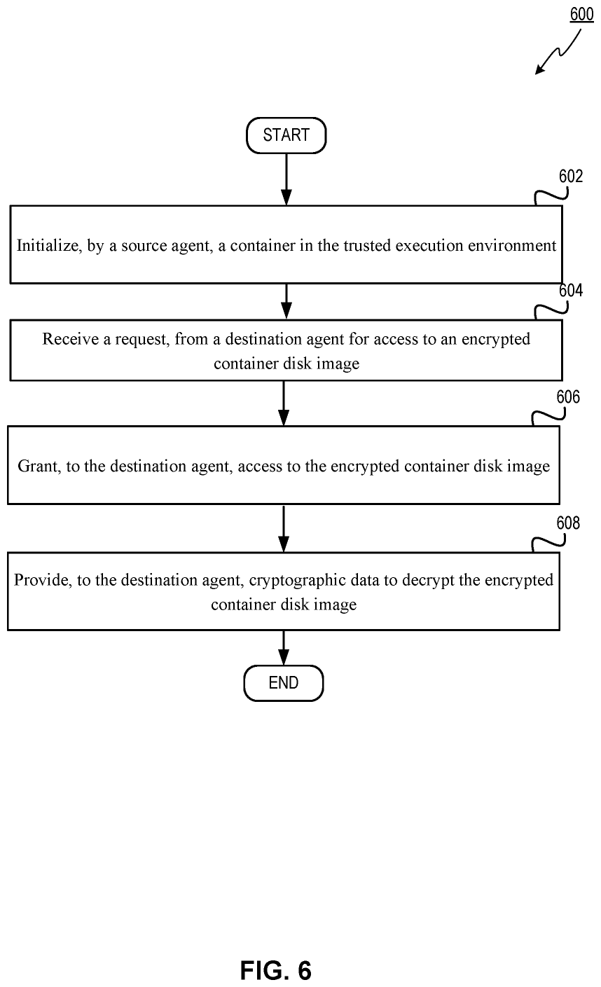

FIG. 6 depicts a flow diagram of an example method 600 for sharing a container disk image of an executable container running in a trusted execution environment, in accordance with one or more aspects of the present disclosure. Method 600 and each of its individual functions, routines, subroutines, or operations may be performed by one or more processors of the computer device executing the method. In certain implementations, method 600 may be performed by a single processing thread. Alternatively, method 600 may be performed by two or more processing threads, each thread executing one or more individual functions, routines, subroutines, or operations of the method. In an illustrative example, the processing threads implementing method 600 may be synchronized (e.g., using semaphores, critical sections, and/or other thread synchronization mechanisms). Alternatively, the processes implementing method 600 may be executed asynchronously with respect to each other.

Method 600 may be performed by one or more processing devices of a computing process, a host, a node, a client device, a server, etc., and may begin at block 602. At block 602, a source agent, running in a trusted execution environment, may initialize a container in the trusted execution environment. In some implementations, to initialize the container, the source agent may first decrypt an encrypted container disk image, and encrypt, using one or more keys generated by the agent, the empty disk image. The source agent may then generate an overlay between a decrypted container disk image and the encrypted empty disk image. In some implementations, prior to the overlay, the source agent may create a file system on the encrypted empty disk image for storing data associated with the container.

At block 604, the source agent may receive a request, from a destination agent (or other computing process such as, for example, a virtual machine, a node, a container, etc.), for access to the encrypted container disk image. In some implementations, the destination agent may be running in a different trusted execution environment than the source agent.

At block 606, the source agent may grant, to the destination agent, access to the encrypted container disk image. In some implementations, the source agent may notify the destination agent of an identifier (e.g., address location, related metadata, etc.) related to requested encrypted container disk image.

At block 608, the source agent may provide, to the destination agent, cryptographic data (e.g., a cryptographic key(s)) to decrypt the encrypted container disk image. For example, the source agent may send the cryptographic data to the destination agent, identify a location of the cryptographic data, etc. The destination may then decrypt the encrypted container disk image, and overlay its own encrypted disk image (an empty disk image encrypted by one or more keys generated by the destination agent) onto the decrypted container disk image. Responsive to completing the operations described herein above with references to block 608, the method may terminate.

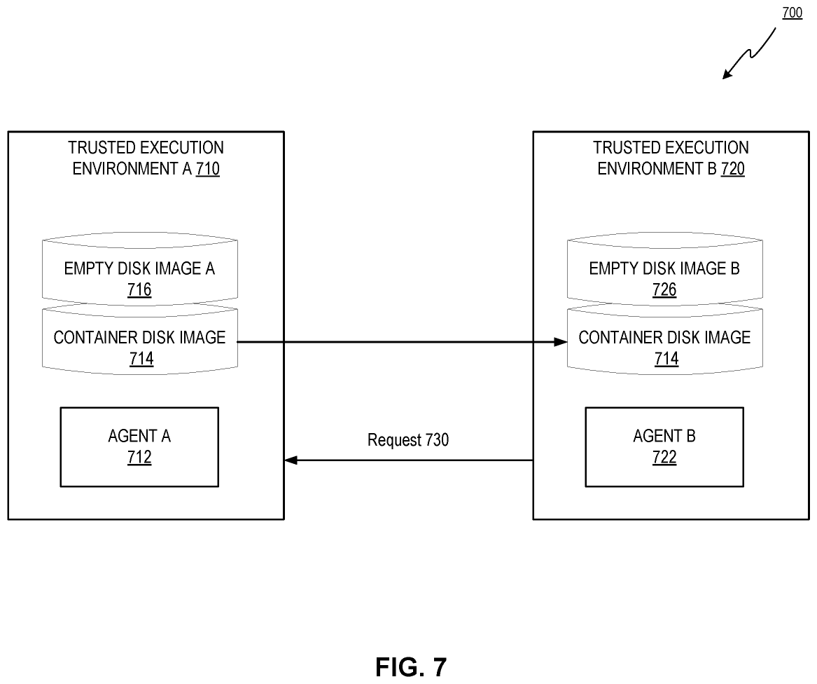

FIG. 7 depicts a block diagram of a computer system 700 operating in accordance with one or more aspects of the present disclosure. One or more of the components of FIG. 1 and/or FIG. 2 may execute on computer system 700. Computer system 700 may be the same or similar to node 112A-C of FIG. 1 and/or computer system 200 of FIG. 2, and may include one or more processors and one or more memory devices. In the example shown, computer system 400 may trusted execution environment A 710 and 720B. Trusted execution environment A 710 may include agent A 712, container disk image 714 and empty disk image A 716. Trusted execution environment B 720 may include agent B 722, container disk image 714 and empty disk image B 726. As will be explained in detail, container disk image 714 may be shared by trusted execution environment A 710 with trusted execution environment B 720.

Agent A 712 may initialize a container in the trusted execution environment. In some implementations, to initialize the container, the source agent may first decrypt encrypted container disk image 714, and encrypt, using one or more keys generated by agent A 712, empty disk image A 716. Agent 712 may then generate an overlay between decrypted container disk image 714 and the encrypted empty disk image A 716. In some implementations, prior to the overlay, agent A 712 may create a file system on the encrypted empty disk image A 716 for storing data associated with the container.

Agent A 712 may receive request 730, from agent B 722, for access to the encrypted container disk image 714. Agent A 712 may grant, to agent B 722, access to the encrypted container disk image 714. In some implementations, agent A 712 may notify the agent B 722 of an identifier (e.g., address location, related metadata, etc.) related to encrypted container disk image 714.

Agent A 712 may provide, to agent B 722, cryptographic data (e.g., a cryptographic key(s)) to decrypt the encrypted container disk image 714. For example, the agent A 712 may send the cryptographic data to agent B 722, identify a location of the cryptographic data, etc. Agent B 722 may then decrypt the encrypted container disk image 714, and overlay encrypted disk image B 726 onto the decrypted container disk image 714.

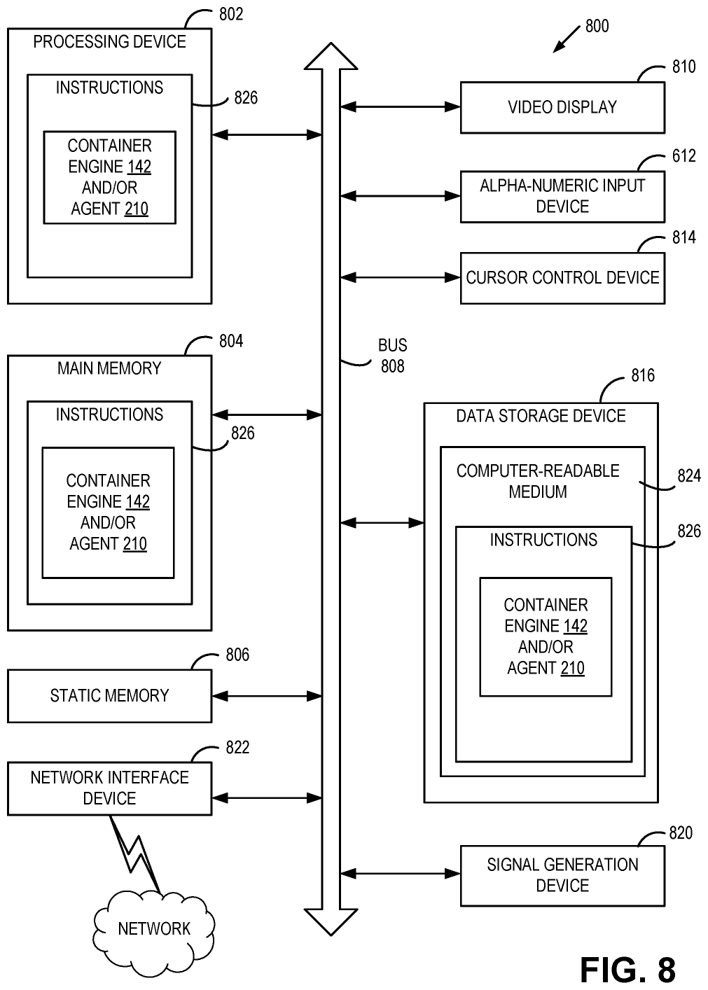

FIG. 8 depicts an example computer system 800 which can perform any one or more of the methods described herein. In one example, computer system 800 may correspond to computer system 100 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a set-top box (STB), a server, a network router, switch or bridge, or any device capable of executing a set of instructions (sequential or otherwise) that specify actions to be taken by that device. Further, while a single computer system is illustrated, the term “computer” shall also be taken to include any collection of computers that individually or jointly execute a set (or multiple sets) of instructions to perform any one or more of the methods discussed herein.

The exemplary computer system 800 includes a processing device 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)), and a data storage device 816, which communicate with each other via a bus 808.

Processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute processing logic (e.g., instructions 826) that includes conflict manager 142 for performing the operations and steps discussed herein (e.g., corresponding to the methods of FIGS. 3, 5, and 6, etc.).

The computer system 800 may further include a network interface device 822. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 820 (e.g., a speaker). In one illustrative example, the video display unit 810, the alphanumeric input device 812, and the cursor control device 814 may be combined into a single component or device (e.g., an LCD touch screen).

The data storage device 816 may include a non-transitory computer-readable medium 824 on which may store instructions 826 that include container engine 142 and/or agent 210 (e.g., corresponding to the method of FIGS. 3, 5, and 6, etc.) embodying any one or more of the methodologies or functions described herein. Conflict manager 142 may also reside, completely or at least partially, within the main memory 804 and/or within the processing device 802 during execution thereof by the computer system 800, the main memory 804 and the processing device 802 also constituting computer-readable media. Container engine 142 and/or agent 210 may further be transmitted or received over a network via the network interface device 822.

While the computer-readable storage medium 824 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Other computer system designs and configurations may also be suitable to implement the system and methods described herein. The following examples illustrate various implementations in accordance with one or more aspects of the present disclosure.

Example 1 is a method comprising identifying, by an agent running in a trusted execution environment, an encrypted first disk image comprising data associated with an executable container; storing an empty second disk image; encrypting, using one or more keys generated by the agent, the second disk image; creating a file system on the encrypted second disk image; decrypting the encrypted first disk image; and generating an overlay between the decrypted first disk image and the encrypted second disk image.

Example 2 is a method of example 1, further comprising granting, to another agent running in another trusted execution environment, access to the encrypted first disk image.

Example 3 is a method of example 2, further comprising providing, to the another agent, cryptographic data to decrypt the encrypted first disk image.

Example 4 is a method of example 1, wherein generating the overlay comprises merging data from the decrypted first disk image and the encrypted second disk image.

Example 5 is a method of example 1, further comprising granting, to the executable container, write access to the empty second disk image.

Example 6 is a method of example 1, wherein the encrypted first disk image comprises one or more read-only layers.

Example 7 is a method of example 1, further comprising presenting, to the agent, the encrypted first disk image and the second disk image as virtual block devices.

Example 8 is a system comprising a memory and a processing device, operatively coupled to the memory, to identify, by an agent running in a trusted execution environment, an encrypted first disk image comprising data associated with an executable container; store an empty second disk image; encrypt, using one or more keys generated by the agent, the second disk image; create a file system on the encrypted second disk image; decrypt the encrypted first disk image; and generate an overlay between the decrypted first disk image and the encrypted second disk image.

Example 9 is a system of example 8, wherein the processing device is further to grant, to another agent running in another trusted execution environment, access to the encrypted first disk image.

Example 10 is a system of example 9, the processing device is further to provide, to the another agent, cryptographic data to decrypt the encrypted first disk image.

Example 11 is a system of example 8, wherein generating the overlay comprises merging data from the decrypted first disk image and the encrypted second disk image.

Example 12 is a system of example 8, the processing device is further to grant, to the executable container, write access to the empty second disk image.

Example 13 is a system of example 8, wherein the encrypted first disk image comprises one or more read-only layers.

Example 14 is a system of example 8, the processing device is further to present, to the agent, the encrypted first disk image and the second disk image as virtual block devices.

Example 15 is a non-transitory machine-readable storage medium storing executable instructions which, when executed by a processing device, cause the processing device to identify, by an agent running in a trusted execution environment, an encrypted first disk image comprising data associated with an executable container; store an empty second disk image; encrypt, using one or more keys generated by the agent, the second disk image; create a file system on the encrypted second disk image; decrypt the encrypted first disk image; and generate an overlay between the decrypted first disk image and the encrypted second disk image.

Example 16 is a non-transitory machine-readable storage medium of example 15, further comprising instructions that cause the processing device to grant, to another agent running in another trusted execution environment, access to the encrypted first disk image.

Example 17 is a non-transitory machine-readable storage medium of example 16, further comprising instructions that cause the processing device to provide, to the another agent, cryptographic data to decrypt the encrypted first disk image.

Example 18 is a non-transitory machine-readable storage medium of example 15, wherein generating the overlay comprises merging data from the decrypted first disk image and the encrypted second disk image.

Example 19 is a non-transitory machine-readable storage medium of example 15, further comprising instructions that cause the processing device to grant, to the executable container, write access to the empty second disk image.

Example 20 is a non-transitory machine-readable storage medium of example 15, wherein the encrypted first disk image comprises one or more read-only layers.

Example 21 is a non-transitory machine-readable storage medium of example 15, further comprising instructions that cause the processing device to present, to the agent, the encrypted first disk image and the second disk image as virtual block devices.

Example 22 is a method comprising initializing, by a source agent, running in a trusted execution environment, a container in the trusted execution environment; receiving a request, from a destination agent, for access to the encrypted container disk image; granting, to the destination agent, access to the encrypted container disk image; and providing, to the destination agent, cryptographic data to decrypt the encrypted container disk image.

Example 23 is a method of example 22, wherein to initialize the container, the source agent may first decrypt an encrypted container disk image, and encrypt, using one or more keys generated by the agent, the empty disk image. The source agent may then generate an overlay between a decrypted container disk image and the encrypted empty disk image. In some implementations, prior to the overlay, the source agent may create a file system on the encrypted empty disk image for storing data associated with the container.

Example 24 is a method of example 22, wherein the destination agent is running in a different trusted execution environment than the source agent.

Example 25 is a method of example 22, the source agent notifies the destination agent of an identifier related to requested encrypted container disk image.

Example 26 is a method of example 22, the destination agent decrypts the encrypted container disk image and overlays its own encrypted empty disk image.

Example 27 is a system comprising a memory and a processing device, operatively coupled to the memory, to initialize, by a source agent, running in a trusted execution environment, a container in the trusted execution environment; receiving a request, from a destination agent, for access to the encrypted container disk image; grant, to the destination agent, access to the encrypted container disk image; and provide, to the destination agent, cryptographic data to decrypt the encrypted container disk image.

Example 28 is a non-transitory machine-readable storage medium storing executable instructions which, when executed by a processing device, cause the processing device to initialize, by a source agent, running in a trusted execution environment, a container in the trusted execution environment; receive a request, from a destination agent, for access to the encrypted container disk image; grant, to the destination agent, access to the encrypted container disk image; and provide, to the destination agent, cryptographic data to decrypt the encrypted container disk image.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

Unless specifically stated otherwise, as apparent from the following discussion, it is appreciated that throughout the description, discussions utilizing terms such as “receiving,” “determining,” “executing,” “rejecting,” “provisioning,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the specific purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general purpose systems may be used with programs in accordance with the teachings herein, or it may prove convenient to construct more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 300 or 500 and one or more of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled

What is claimed is:

1. A method comprising:
identifying, by an agent running in a trusted execution environment, an encrypted first disk image comprising data associated with an executable container;
storing an empty second disk image;
encrypting, using one or more keys generated by the agent, the second disk image;
creating a file system on the encrypted second disk image;
decrypting the encrypted first disk image; and
generating an overlay between the decrypted first disk image and the encrypted second disk image.

2. The method of claim 1, further comprising:
granting, to another agent running in another trusted execution environment, access to the encrypted first disk image.

3. The method of claim 2, further comprising:
providing, to the another agent, cryptographic data to decrypt the encrypted first disk image.

4. The method of claim 1, wherein generating the overlay comprises merging data from the decrypted first disk image and the encrypted second disk image.

5. The method of claim 1, further comprising:
granting, to the executable container, write access to the empty second disk image.

6. The method of claim 1, wherein the encrypted first disk image comprises one or more read-only layers.

7. The method of claim 1, further comprising:
presenting, to the agent, the encrypted first disk image and the second disk image as virtual block devices.

8. A system comprising:
a memory;
a processing device, operatively coupled to the memory, to:
identify, by an agent running in a trusted execution environment, an encrypted first disk image comprising data associated with an executable container;
store an empty second disk image;
encrypt, using one or more keys generated by the agent, the second disk image;
create a file system on the encrypted second disk image;
decrypt the encrypted first disk image; and
generating an overlay between the decrypted first disk image and the encrypted second disk image.

9. The system of claim 8, wherein the processing device is further to:
grant, to another agent running in another trusted execution environment, access to the encrypted first disk image.

10. The system of claim 9, wherein the processing device is further to:
provide, to the another agent, cryptographic data to decrypt the encrypted first disk image.

11. The system of claim 8, wherein generating the overlay comprises merging data from the decrypted first disk image and the encrypted second disk image.

12. The system of claim 8, wherein the processing device is further to:
grant, to the executable container, write access to the empty second disk image.

13. The system of claim 8, wherein the encrypted first disk image comprises one or more read-only layers.

14. The system of claim 8, wherein the processing device is further to:
present, to the agent, the encrypted first disk image and the second disk image as virtual block devices.

15. A non-transitory machine-readable storage medium storing executable instructions which, when executed by a processing device, cause the processing device to:
identify, by an agent running in a trusted execution environment, an encrypted first disk image comprising data associated with an executable container;
store an empty second disk image;
encrypt, using one or more keys generated by the agent, the second disk image;
create a file system on the encrypted second disk image;
decrypt the encrypted first disk image; and
generate an overlay between the decrypted first disk image and the encrypted second disk image.

16. The non-transitory machine-readable storage medium of claim 15, further comprising instructions that cause the processing device to:
grant, to another agent running in another trusted execution environment, access to the encrypted first disk image.

17. The non-transitory machine-readable storage medium of claim 16, further comprising instructions that cause the processing device to:
provide, to the another agent, cryptographic data to decrypt the encrypted first disk image.

18. The non-transitory machine-readable storage medium of claim 15, wherein generating the overlay comprises merging data from the decrypted first disk image and the encrypted second disk image.

19. The non-transitory machine-readable storage medium of claim 15, further comprising instructions that cause the processing device to:
grant, to the executable container, write access to the empty second disk image.

20. The non-transitory machine-readable storage medium of claim 15, wherein the encrypted first disk image comprises one or more read-only layers.
